(19) United States
(12) Patent Application Publication
(10) Pub. No.: US 2018/0258840 A1
(43) Pub. Date: Sep. 13, 2018

(54) EXHAUST TURBINE POWER GENERATING SYSTEM AND CONTROL DEVICE FOR THE SAME

(71) Applicant: TOYOTA JIDOSHA KABUSHIKI KAISHA, Toyota-shi (JP)

(72) Inventor: Keiji YOEDA, Numazu-shi (JP)

(73) Assignee: TOYOTA JIDOSHA KABUSHIKI KAISHA, Toyota-shi (JP)

(21) Appl. No.: 15/912,716

(22) Filed: Mar. 6, 2018

(30) Foreign Application Priority Data
Mar. 7, 2017 (JP) 2017-042824

(51) Int. Cl. F02B 37/12; F01N 5/04; F02B 39/16

(52) U.S. Cl. CPC F02B 37/12; F01N 5/04; F05B 2220/706; F05B 2220/602; F02B 39/16

(57) ABSTRACT

An exhaust turbine power generating system includes an internal combustion engine, an exhaust turbine power generator, and an electronic control unit configured to individually control a first electric power generation load of the exhaust turbine power generator in a first period and a second electric power generation load of the exhaust turbine power generator in a second period and to perform control such that the second electric power generation load of the exhaust turbine power generator becomes equal to or smaller than the first electric power generation load. The first period is a period that starts at an exhaust start timing in an exhaust cycle and the second period is a period after the first period in the exhaust cycle. The exhaust start timing is a timing at which the exhaust gas starts to be discharged toward the turbine from an arbitrary cylinder in the internal combustion engine.

### INCORPORATION BY REFERENCE

The disclosure of Japanese Patent Application No. 2017-042824 filed on Mar. 7, 2017 including the specification, drawings and abstract is incorporated herein by reference in its entirety.

### BACKGROUND

### 1. Technical Field

The disclosure relates to an exhaust turbine power generating system that performs electric power generation by using exhaust energy from an internal combustion engine and relates to a control device for an exhaust turbine power generating system.

### 2. Description of Related Art

Japanese Unexamined Patent Application Publication No. 2015-21448 (JP 2015-21448 A) discloses an exhaust turbine power generating system that performs electric power generation by using exhaust energy of an internal combustion engine. An exhaust gas flow path in the exhaust turbine power generating system is divided into two systems. Exhaust gas in a blowdown stream is supplied to a turbine unit in an exhaust turbine power generator through a first exhaust gas flow path. The first exhaust gas flow path upstream of the turbine unit is provided with an exhaust receiver that stores exhaust energy. Exhaust gas in a scavenging stream flows through a second exhaust gas flow path while bypassing the exhaust receiver and the turbine unit.

### SUMMARY

In the exhaust turbine power generating system disclosed in JP 2015-21448 A, electric power generation is performed when exhaust gas in the blowdown stream is supplied to a turbine. However, exhaust energy that is input to the turbine during a period between a period of the blowdown stream and a period of the next blowdown stream is relatively small. When the same electric power generation control as in the period of the blowdown stream is continued even in a period in which exhaust energy is relatively small, there is a large decrease in turbine rotation rate. In other words, it becomes difficult to maintain the turbine rotation rate at an appropriate rotation rate for appropriate electric power generation. In an engine operating region in which the absolute value of exhaust energy becomes sufficiently large, it may be possible to perform appropriate electric power generation. However, a limit on an engine operating region suitable for electric power generation means a decrease in electric power generation opportunity, which is not preferable.

The disclosure provides a technique with which it is possible to expand an engine operating region suitable for electric power generation in an exhaust turbine power generating system that performs electric power generation by using exhaust energy from an internal combustion engine.

A first aspect of the disclosure relates to an exhaust turbine power generating system that includes an internal combustion engine, an exhaust turbine power generator, and an electronic control unit. The exhaust turbine power generator is configured to perform electric power generation by rotating a turbine by using exhaust gas from the internal combustion engine. The electronic control unit is configured to individually control a first electric power generation load of the exhaust turbine power generator in a first period and a second electric power generation load of the exhaust turbine power generator in a second period and to perform control such that the second electric power generation load of the exhaust turbine power generator becomes equal to or smaller than the first electric power generation load. The first period is a period that starts at an exhaust start timing in an exhaust cycle, the second period is a period after the first period in the exhaust cycle, the exhaust start timing is a timing at which the exhaust gas starts to be discharged toward the turbine from an arbitrary cylinder in the internal combustion engine, and the exhaust cycle is a period between two temporally consecutive exhaust start timings.

A second aspect of the disclosure relates to a control device for an exhaust turbine power generating system. The exhaust turbine power generating system includes an internal combustion engine and an exhaust turbine power generator and the exhaust turbine power generator is configured to perform electric power generation by rotating a turbine by using exhaust gas from the internal combustion engine. The control device includes an electronic control unit configured to individually control a first electric power generation load of the exhaust turbine power generator in a first period and a second electric power generation load of the exhaust turbine power generator in a second period and to perform control such that the second electric power generation load of the exhaust turbine power generator becomes equal to or smaller than the first electric power generation load. The first period is a period that starts at an exhaust start timing in an exhaust cycle, the second period is a period after the first period in the exhaust cycle, the exhaust start timing is a timing at which the exhaust gas starts to be discharged toward the turbine from an arbitrary cylinder in the internal combustion engine, and the exhaust cycle is a period between two temporally consecutive exhaust start timings.

According to the aspects of the disclosure, exhaust energy in the first period in the exhaust cycle is relatively large and exhaust energy in the second period in the exhaust cycle is relatively small, the second period being a period after the first period. The exhaust turbine power generating system according to the aspects controls the electric power generation load of the exhaust turbine power generator in consideration of a change in exhaust energy during the exhaust cycle.

More specifically, the electronic control unit individually controls the first electric power generation load in the first period and the second electric power generation load in the second period such that the second electric power generation load becomes equal to or smaller than the first electric power generation load. With electric power generation load control as described above, it is possible to effectively suppress a decrease in turbine rotation rate in the second period in which the exhaust energy is relatively small. As a result, it is easy to maintain the turbine rotation rate at an appropriate rotation rate and to continuously perform appropriate electric power generation.

Particularly, since it is possible to effectively suppress a decrease in turbine rotation rate even in a case where the absolute value of the exhaust energy is further smaller and there is no significant increase in turbine rotation rate, it is possible to maintain the turbine rotation rate at an appropriate rotation rate. The above-described fact means expansion of an engine operating region suitable for electric power generation. The electric power generation opportunity is increased due to the expansion of the engine operating region suitable for electric power generation.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a schematic diagram illustrating an example of the configuration of an exhaust turbine power generating system according to an embodiment of the disclosure;

FIG. 2 is a timing chart for describing an exhaust cycle in the embodiment of the disclosure;

FIG. 3 is a conceptual diagram for describing a comparative example;

FIG. 4 is a graph for describing an engine operating region suitable for electric power generation control in the comparative example;

FIG. 5 is a conceptual diagram for describing the outline of electric power generation control according to the embodiment of the disclosure;

FIG. 6 is a diagram illustrating an example of a circuit configuration for electric power generation load control according to the embodiment of the disclosure;

FIG. 7 is a diagram for describing the electric power generation load control (duty control) according to the embodiment of the disclosure;

FIG. 8 is a diagram illustrating another example of the circuit configuration for the electric power generation load control according to the embodiment of the disclosure;

FIG. 9 is a conceptual diagram for describing a first example of the electric power generation load control according to the embodiment of the disclosure;

FIG. 10 is a conceptual diagram for describing the first example of the electric power generation load control according to the embodiment of the disclosure;

FIG. 11 is a flowchart illustrating the first example of the electric power generation load control according to the embodiment of the disclosure;

FIG. 12 is a conceptual diagram for describing a second example of the electric power generation load control according to the embodiment of the disclosure;

FIG. 13 is a flowchart illustrating the second example of the electric power generation load control according to the embodiment of the disclosure;

FIG. 14 is a flowchart illustrating a third example of the electric power generation load control according to the embodiment of the disclosure; and

FIG. 15 is a schematic diagram illustrating a modification example of the exhaust turbine power generating system according to the embodiment of the disclosure.

### DETAILED DESCRIPTION OF EMBODIMENTS

An embodiment of the disclosure will be described with reference to attached drawings.

### 1. Configuration of Exhaust Turbine Power Generating System

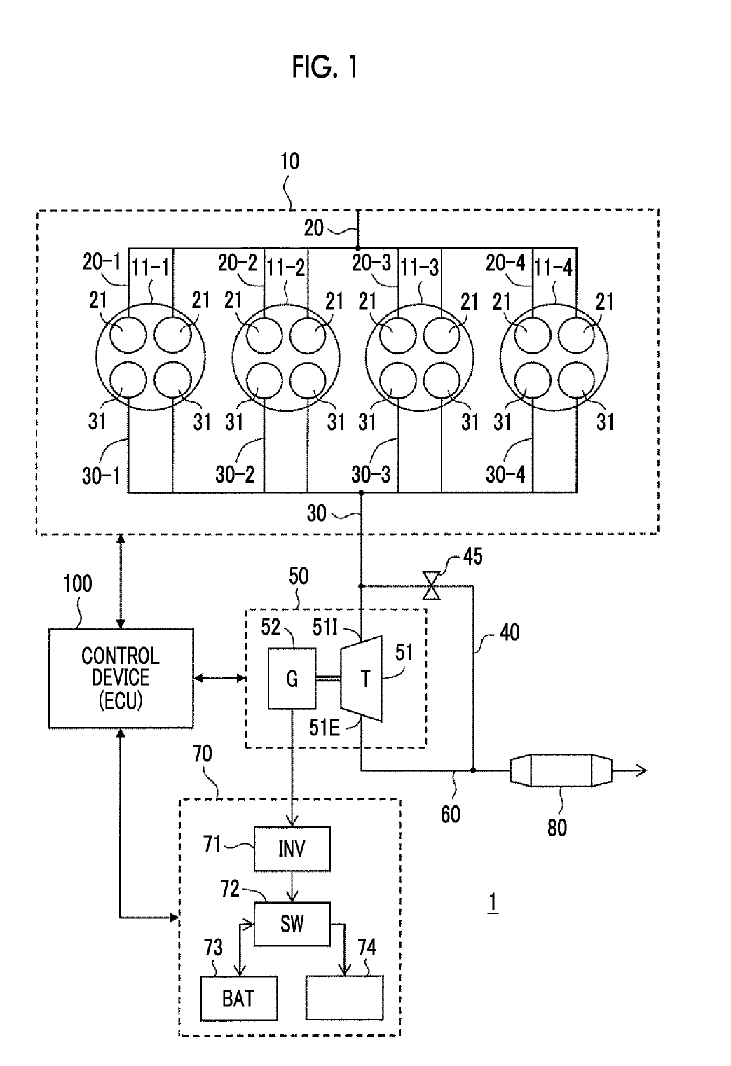

FIG. 1 is a schematic diagram illustrating an example of the configuration of an exhaust turbine power generating system 1 according to the embodiment of the disclosure. The exhaust turbine power generating system 1 includes an internal combustion engine 10 (engine), an exhaust turbine power generator 50, an electric device 70, and a control device 100 as main components.

The internal combustion engine 10 includes cylinders 11 (combustion chamber) in which combustion is performed. Although four cylinders 11-1, 11-2, 11-3, 11-4 are illustrated in FIG. 1, the number of the cylinders 11 is optional. In each cylinder 11, a piston (not shown) is provided such that the piston can reciprocate vertically. The vertical reciprocating motion of the piston results in intake and exhaust.

An intake pipe 20 (intake port) is provided to supply intake gas to the cylinders 11. Opening portions of the intake pipe 20 with respect to the cylinders 11 are intake opening portions 21. That is, the intake pipe 20 is connected to the cylinders 11 via the intake opening portions 21. The intake opening portions 21 are provided with an intake valve (not shown) such that the intake valve can be opened and closed. Supply of intake gas to the cylinders 11 is controlled by controlling opening and closing of the intake valve. In an example illustrated in FIG. 1, intake pipes 20-i are respectively connected to the cylinders 11-i (i=1 to 4).

An exhaust pipe 30 (exhaust port) is provided to discharge exhaust gas from the cylinders 11. Opening portions of the exhaust pipe 30 with respect to the cylinders 11 are exhaust opening portions 31. That is, the exhaust pipe 30 is connected to the cylinders 11 via the exhaust opening portions 31. The exhaust opening portions 31 are provided with an exhaust valve (not shown) such that the exhaust valve can be opened and closed. Discharge of exhaust gas from the cylinders 11 is controlled by controlling the opening and closing of the exhaust valve. In the example illustrated in FIG. 1, exhaust pipes 30-i are respectively connected to the cylinders 11-i (i=1 to 4).

The exhaust turbine power generator 50 is connected to the exhaust pipe 30 and performs electric power generation by using exhaust gas from the internal combustion engine 10. More specifically, the exhaust turbine power generator 50 includes a turbine 51 and a generator 52 that is connected to an output shaft of the turbine 51. A gas inlet and a gas outlet of the turbine 51 are a turbine inlet portion 511 and a turbine outlet portion 51E, respectively. Exhaust gas from the internal combustion engine 10 is supplied to the turbine 51 through the turbine inlet portion 511 and the turbine 51 is rotated by the supplied exhaust gas. As the turbine 51 rotates, the generator 52 is driven and generates electric power. As described above, the exhaust turbine power generator 50 converts exhaust energy from the internal combustion engine 10 to electric energy.

The turbine outlet portion 51E of the turbine 51 is connected to a turbine downstream side exhaust pipe 60. Exhaust gas passing through the turbine 51 flows into the turbine downstream side exhaust pipe 60 from the turbine outlet portion 51E. A catalyst 80 for controlling exhaust gas is disposed in the middle of the turbine downstream side exhaust pipe 60.

A bypass exhaust pipe 40 that bypasses the turbine 51 is provided to directly connect the exhaust pipe 30 upstream of the turbine 51 and the turbine downstream side exhaust pipe 60. In order to adjust the amount of exhaust gas flowing in the bypass exhaust pipe 40, a waste gate valve 45 is disposed in the bypass exhaust pipe 40.

The electric device 70 uses or stores electric power generated by the exhaust turbine power generator 50. More specifically, the electric device 70 includes an inverter 71, a switch 72, a battery 73, and an electrical load 74. Electric power generated by the exhaust turbine power generator 50 is supplied to the battery 73 or the electrical load 74 after being converted by the inverter 71. Switching between supply of the electric power to the battery 73 and supply of the electric power to the electrical load 74 can be performed by using the switch 72. It is also possible to supply electric power discharged from the battery 73 to the electrical load 74 by switching the switch 72. For example, in the case of a hybrid vehicle, the electrical load 74 includes a vehicle driving motor.

The control device 100 controls the operation of the internal combustion engine 10, the exhaust turbine power generator 50, and the electric device 70. Typically, the control device 100 is a microcomputer provided with a processor, a storage device, and an input and output interface. The control device 100 is also called an electronic control unit (ECU). The storage device of the control device 100 stores a control program for performing various types of control. When the processor of the control device 100 executes the control program, the various types of control are realized.

More specifically, the internal combustion engine 10, the exhaust turbine power generator 50, and the electric device 70 are provided with a group of sensors that detects the operation state of each device. The control device 100 receives detection information indicating the operation state of each device from the group of sensors. The control device 100 controls the operation of the internal combustion engine 10 by controlling the timing of opening and closing of the throttle valve, the intake valve, and the exhaust valve, fuel injection, or the like based on the detection information. In addition, the control device 100 controls an electric power generation load (electric power generation duty) or the like of the exhaust turbine power generator 50 based on the detection information. Furthermore, the control device 100 controls charging and discharging of the battery 73 and supply of electric power to the electrical load 74 by controlling the inverter 71 and the switch 72 based on the detection information.

### 2. Outline of Electric Power Generation Control in Embodiment

### 2-1. Description on Exhaust Cycle

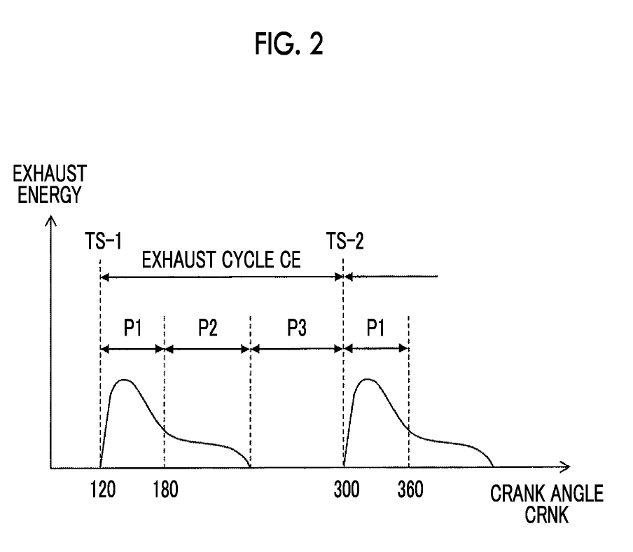

FIG. 2 is a timing chart for describing an exhaust cycle CE in the embodiment. The horizontal axis represents the crank angle CRNK and the vertical axis represents the exhaust energy. Here, the exhaust energy is the energy of exhaust gas discharged to the exhaust pipe 30 that is connected to the turbine 51 and corresponds to the energy of exhaust gas input to the turbine 51.

When the exhaust valve is opened in an arbitrary cylinder 11 of the internal combustion engine 10, exhaust gas is discharged to the exhaust pipe 30 from the cylinder 11 and is input to the turbine 51. Hereinafter, a timing at which discharge of exhaust gas toward the turbine 51 from the cylinder 11 is started will be referred to as an “exhaust start timing TS”. The exhaust start timing corresponds to the timing of opening of the exhaust valve.

The exhaust start timing TS comes periodically. For example, in the configuration illustrated in FIG. 1, the respective exhaust valves of the four cylinders 11-1, 11-2, 11-3, 11-4 are opened subsequently for every 180 degrees of crank angle. That is, the exhaust start timing TS comes every 180 degrees of crank angle. In FIG. 2, two temporally consecutive exhaust start timings TS are represented by “TS-1” and “TS-2”. A period between the two consecutive exhaust start timings TS-1, TS-2 is the “exhaust cycle CE” in the embodiment. The length of the exhaust cycle CE is inversely proportional to an engine rotation rate. That is, the engine rotation rate decreases, the exhaust cycle CE is lengthened.

As illustrated in FIG. 2, the exhaust energy in one exhaust cycle CE is not constant. The exhaust energy is relatively high at an initial stage of the exhaust cycle CE and becomes small with time.

More specifically, before the exhaust valve is opened, in a combustion and expansion stroke in the internal combustion engine 10, the temperature and the pressure in the cylinders 11 are increased. Therefore, a high-temperature and high-pressure exhaust gas is discharged at a high speed that is close to the speed of sound immediately after the exhaust valve is opened. An exhaust stream that is discharged at an initial stage of an exhaust stroke as described above is called a “blowdown stream”. In the initial stage of the exhaust stroke, the exhaust energy becomes relatively large due to the blowdown stream.

The pressure in the cylinders 11 is decreased to a pressure close to the atmospheric pressure after the blowdown stream. Remaining gas in the cylinders 11 is pushed out toward the exhaust pipe 30 due to rising of the piston. An exhaust gas stream pushed out by the piston as described above will be referred to as a “scavenging stream”. The energy of the scavenging stream is smaller than the energy of the blowdown stream. That is, exhaust energy in a late stage of the exhaust stroke is relatively smaller than exhaust energy in the initial stage of the exhaust stroke.

As illustrated in FIG. 2, the exhaust cycle CE is divided into a plurality of periods according to the size of exhaust energy. First, a first period P1 is a period during the initial stage of the exhaust stroke in which the exhaust energy becomes relatively large due to the blowdown stream. The first period P1 starts at the exhaust start timing TS that is the timing of the start of the exhaust cycle CE. The first period P1 starts at the exhaust start timing TS and continues until the crank angle changes by 60 degrees. The first period P1 in the exhaust cycle CE becomes relatively short as the engine rotation rate decreases and becomes relatively long as the amount of exhaust gas increases.

A second period P2 is a period after the first period P1 and is a period in which the exhaust energy becomes relatively small. As illustrated in FIG. 2, a period after the first period P1 may be divided into the second period P2 that corresponds to the late stage of the exhaust stroke and a third period P3 in which the exhaust energy becomes zero. Alternatively, the entire period after the first period P1 may be called the second period P2. In either case, the total amount of exhaust energy in a period after the first period P1 is smaller than the total amount of exhaust energy in the first period P1.

### 2-2. Electric Power Generation Control in Comparative Example

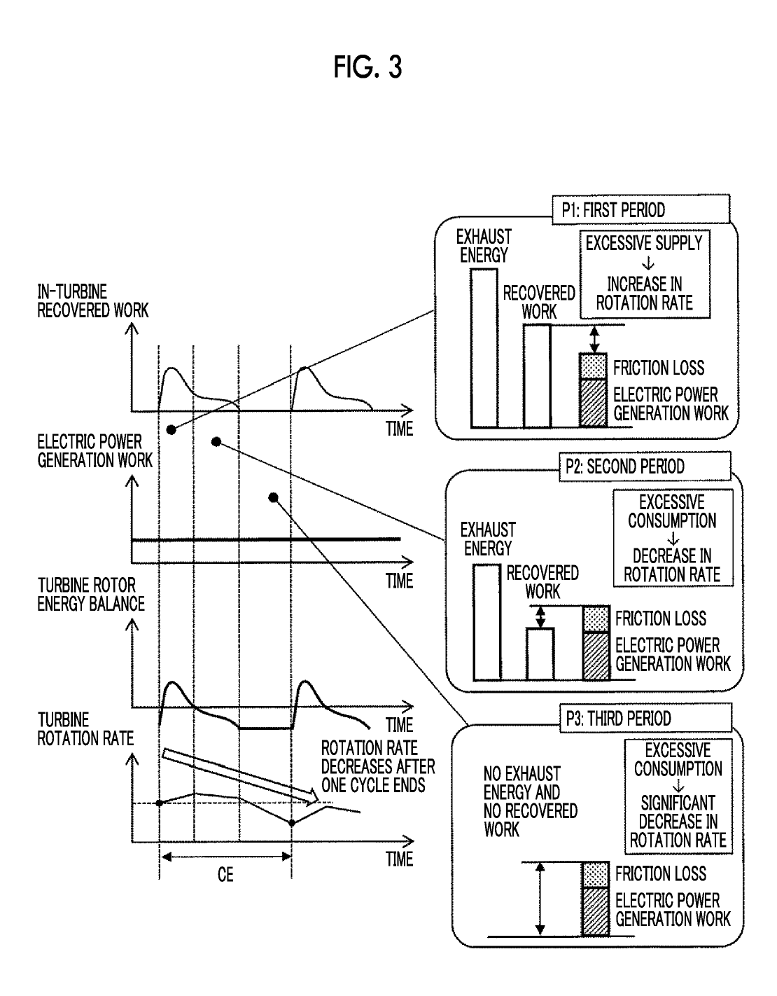

In order to facilitate understanding of the characteristics of electric power generation control in the embodiment, a comparative example will be described first. FIG. 3 is a conceptual diagram for describing the comparative example. FIG. 3 illustrates a temporal change in parameters (in-turbine recovered work, electric power generation work, turbine rotor energy balance, and turbine rotation rate) related to operation of the exhaust turbine power generator 50. The in-turbine recovered work is proportional to the exhaust energy (refer to FIG. 2) and increases as the exhaust energy becomes large. In the comparative example, the electric power generation work is maintained constant during the exhaust cycle CE.

In the first period P1, the exhaust energy is relatively large and the in-turbine recovered work is also relatively large. Therefore, even when electric power is generated, the in-turbine recovered work is larger than consumed energy (sum of electric power generation work and friction loss). Since the in-turbine recovered work becomes excessive, the turbine rotor energy balance becomes positive and the turbine rotation rate increases.

In the second period P2, the exhaust energy becomes relatively small and the in-turbine recovered work also becomes relatively small. When the same electric power generation work as in the first period P1 is maintained in such a situation, the consumed energy becomes larger than the in-turbine recovered work. Since the in-turbine recovered work is insufficient, the turbine rotor energy balance becomes negative and the turbine rotation rate decreases.

In the third period P3, the exhaust energy and the in-turbine recovered work are zero. When the same electric power generation work as in the first period P1 is maintained in such a situation, the turbine rotation rate further decreases.

In an example illustrated in FIG. 3, it can be found that the turbine rotation rate at the end of one exhaust cycle CE is lower than that at the start of the one exhaust cycle CE when comparing the turbine rotation rate at the time of the start of the one exhaust cycle CE and the turbine rotation rate at the time of the end of the one exhaust cycle CE. The above-described fact means that it is not possible to maintain the turbine rotation rate at an appropriate rotation rate for appropriate electric power generation. That is, it is not possible to continuously perform electric power generation at the same operating point.

As described above, in the case of the comparative example, even in the second period P2 and the third period P3 in which the exhaust energy is relatively small, the same electric power generation control as in the first period P1 in which the exhaust energy is relatively large is performed. As a result, the turbine rotation rate significantly decreases, and thus it is difficult to maintain the turbine rotation rate at an appropriate rotation rate and to continuously perform appropriate electric power generation. In an engine operating region in which the “absolute value” of the exhaust energy becomes sufficiently large, since the turbine rotation rate is likely to increase, it may be possible to perform electric power generation control in the comparative example. However, a limit on an engine operating region suitable for electric power generation means a decrease in electric power generation opportunity, which is not preferable.

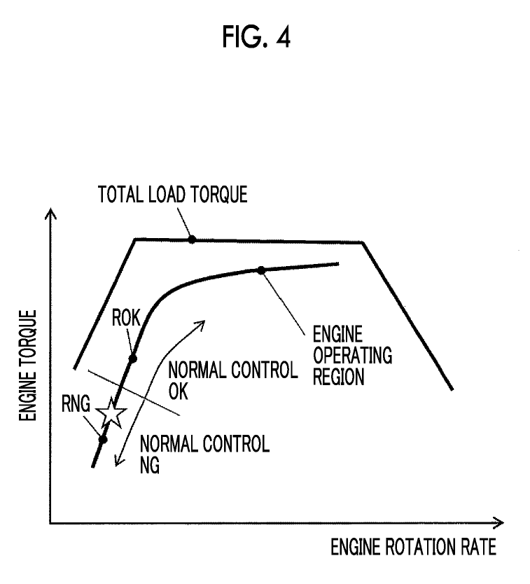

FIG. 4 is a graph for describing an engine operating region suitable for electric power generation control in the comparative example. The horizontal axis represents the engine rotation rate and the vertical axis represents the engine torque. As the engine rotation rate increases, the “absolute value” of the exhaust energy increases. A region ROK in FIG. 4 is an engine operating region suitable for electric power generation control (normal control) in the comparative example. Meanwhile, a region RNG is an engine operating region that is not suitable for the electric power generation control in the comparative example. The example illustrated in FIG. 3 corresponds to the case of an operation state represented by a star mark in the engine operating region RNG. An object of the present disclosure is to appropriately perform electric power generation even in the operation state represented by the star mark, that is, to expand the engine operating region ROK.

### 2-3. Outline of Electric Power Generation Control in Embodiment

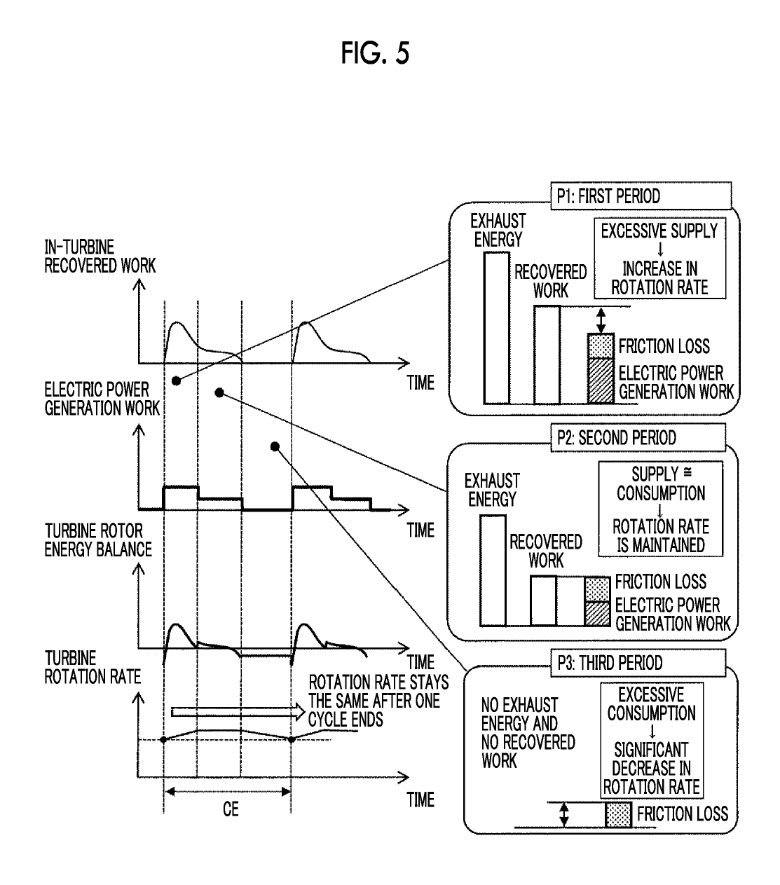

FIG. 5 is a conceptual diagram for describing the outline of electric power generation control according to the embodiment. The format of FIG. 5 is the same as the format of FIG. 3. In addition, the operation state of the engine corresponds to the operation state represented by the star mark in FIG. 4 as with the case of the comparative example. According to the embodiment, variable control of the electric power generation work is performed in consideration of a change in exhaust energy (in-turbine recovered work) during the exhaust cycle CE.

The first period P1 is the same as that in the case of the comparative example (refer to FIG. 3). That is, the exhaust energy is relatively large and the in-turbine recovered work is also relatively large. Therefore, even when electric power is generated, the in-turbine recovered work is larger than consumed energy (sum of electric power generation work and friction loss). Since the in-turbine recovered work becomes excessive, the turbine rotor energy balance becomes positive and the turbine rotation rate increases.

In the second period P2, the exhaust energy becomes relatively small and the in-turbine recovered work also becomes relatively small. In consideration of the decrease in in-turbine recovered work, the electric power generation work in the second period P2 is controlled to be smaller than the electric power generation work in the first period P1. Therefore, it is possible to equalize the consumed energy and the in-turbine recovered work. As a result, a decrease in turbine rotation rate is effectively suppressed.

In the third period P3, the exhaust energy and the in-turbine recovered work are zero. The electric power generation work in the third period P3 is set to be zero. The turbine rotation rate slightly decreases due to friction loss.

In an example illustrated in FIG. 5, it can be found that the turbine rotation rate at the end of one exhaust cycle CE is the same as that at the start of the one exhaust cycle CE when comparing the turbine rotation rate at the time of the start of the one exhaust cycle CE and the turbine rotation rate at the time of the end of the one exhaust cycle CE. The above-described fact means that it is possible to maintain the turbine rotation rate at an appropriate rotation rate for appropriate electric power generation. That is, it is possible to continuously perform electric power generation at the same operating point.

As described above, according to the embodiment, variable control of the electric power generation work is performed in consideration of the in-turbine recovered work. Accordingly, it is possible to maintain the turbine rotation rate at an appropriate rotation rate and to continuously perform appropriate electric power generation even in the operation state represented by the star mark in FIG. 4. The above-described fact means that the engine operating region ROK suitable for electric power generation is expanded. Therefore, the electric power generation opportunity is increased in comparison with the case of the comparative example.

### 3. Electric Power Generation Load Control Performed by Electronic Control Unit

The control device 100 of the exhaust turbine power generating system 1 according to the embodiment controls the “electric power generation load (electric power generation duty)” of the exhaust turbine power generator 50 to control the electric power generation work.

### 3-1. Example of Circuit Configuration for Electric Power Generation Load Control

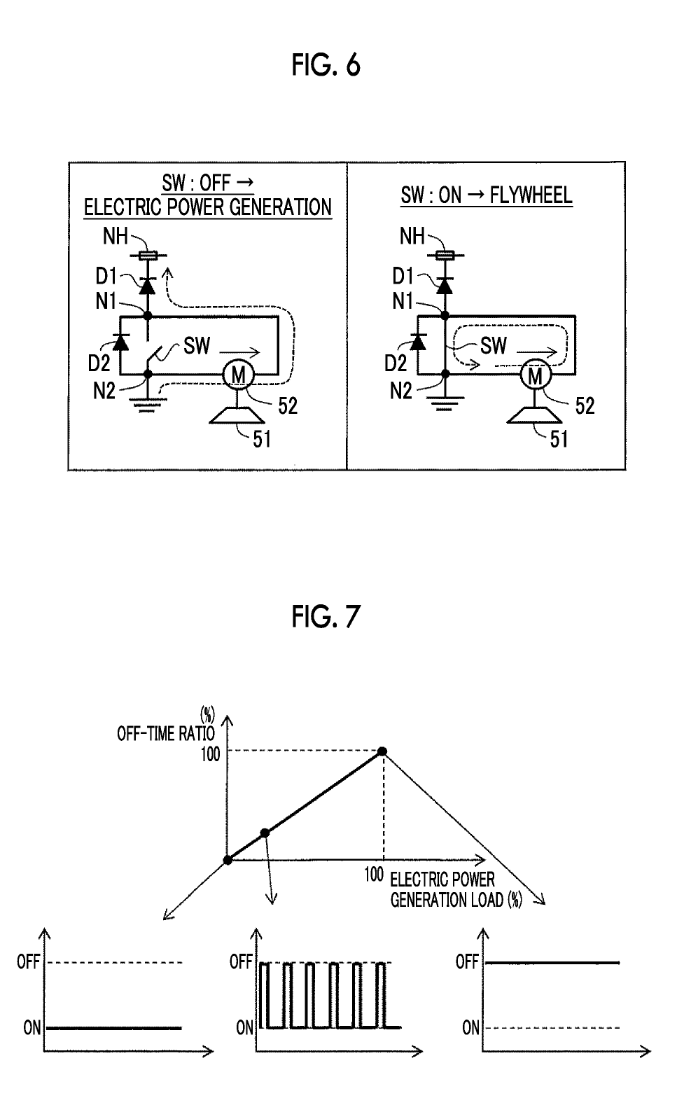

FIG. 6 illustrates an example of a circuit configuration for electric power generation load control according to the embodiment. The circuit configuration is included in, for example, the exhaust turbine power generator 50. Specifically, a node N1 is connected to a high potential side node NH via a diode D1. A node N2 is connected to the ground. A diode D2, a switch SW, and the generator 52 are connected in parallel between the node N1 and the node N2. On-off control of the switch SW is performed by the control device 100.

When the turbine 51 recovers the exhaust energy and the turbine 51 rotates, a rotor in the generator 52 rotates and an induced electromotive force is generated on a coil in the generator 52. The direction of the induced electromotive force in the generator 52 is represented by an arrow in FIG. 6. Here, in a case where the switch SW is turned off, electricity is drawn toward the high potential side node NH and the exhaust turbine power generator 50 enters an “electric power generation state”. Meanwhile, in a case where the switch SW is turned on, a closed circuit (flywheel) as illustrated in FIG. 6 is formed, and thus electricity is not drawn and the exhaust turbine power generator 50 enters a “non-electric power generation state”.

FIG. 7 is a diagram for describing electric power generation load control (duty control) performed by the control device 100. The horizontal axis in each graph in FIG. 7 represents the electric power generation load and the vertical axis in each graph in FIG. 7 represents the OFF-time ratio. The OFF-time ratio is the ratio of a time for which the switch SW is in the turned-off state to a certain period of time, that is, the duty ratio. In a case where the OFF-time ratio is 0%, the switch SW is in the turned-on state at all times and the electric power generation load is 0% (stoppage of electric power generation). Meanwhile, in a case where the OFF-time ratio is 100%, the switch SW is in the turned-off state at all times and the electric power generation load is 100% (electric power generation at full rate). The electric power generation load increases in proportion to the OFF-time ratio. Accordingly, the control device 100 can control the electric power generation load within a range of 0% to 100% by performing the on-off control of the switch SW.

### 3-2. Outline and Effect of Electric Power Generation Load Control in Embodiment

According to the embodiment, the control device 100 controls the electric power generation load in consideration of a change in exhaust energy (in-turbine recovered work) during the exhaust cycle CE. For description, the electric power generation load in the first period P1 will be referred to as a “first electric power generation load DUTY1” and the electric power generation load in the second period P2 will be referred to as a “second electric power generation load DUTY2”. The control device 100 individually controls the first electric power generation load DUTY1 and the second electric power generation load DUTY2.

For example, in an example illustrated in FIG. 5, the control device 100 sets the second electric power generation load DUTY2 to be smaller than the first electric power generation load DUTY1. Accordingly, it is possible to effectively suppress a decrease in turbine rotation rate in the second period P2 in which the exhaust energy is relatively small. As a result, it is easy to maintain the turbine rotation rate at an appropriate rotation rate and to continuously perform appropriate electric power generation. Setting the second electric power generation load DUTY2 to be smaller than the first electric power generation load DUTY1 as described above is particularly effective in the operation state in which the absolute value of the exhaust energy is further smaller (refer to star mark in FIG. 4).

As described below, in a case where the absolute value of the exhaust energy is sufficiently large, the second electric power generation load DUTY2 may be set to have the same level as the first electric power generation load DUTY1. Even in this case, the first electric power generation load DUTY1 is not smaller than the second electric power generation load DUTY2.

As described above, the control device 100 according to the embodiment individually controls the first electric power generation load DUTY1 and the second electric power generation load DUTY2 such that the second electric power generation load DUTY2 becomes equal to or smaller than the first electric power generation load DUTY1. Through the electric power generation load control as described above, it is possible to effectively suppress a decrease in turbine rotation rate in the second period P2 in which the exhaust energy is relatively small. As a result, it is easy to maintain the turbine rotation rate at an appropriate rotation rate and to continuously perform appropriate electric power generation.

Particularly, since it is possible to effectively suppress a decrease in turbine rotation rate even in a case where the absolute value of the exhaust energy is further smaller and there is no significant increase in turbine rotation rate, it is possible to maintain the turbine rotation rate at an appropriate rotation rate. The above-described fact means expansion of the engine operating region ROK (refer to FIG. 4) suitable for electric power generation. The electric power generation opportunity is increased due to the expansion of the engine operating region ROK suitable for electric power generation.

### 3-3. Another Example of Circuit Configuration for Electric Power Generation Load Control

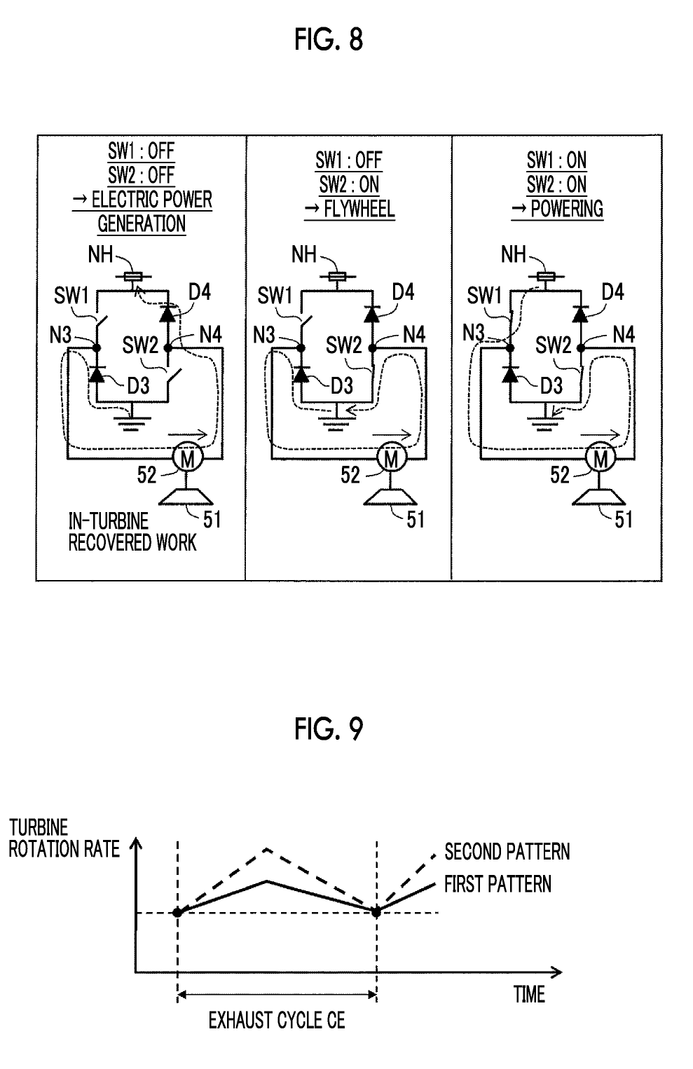

FIG. 8 illustrates another example of a circuit configuration for electric power generation load control according to the embodiment. The circuit configuration is included in, for example, the exhaust turbine power generator 50. Specifically, a node N3 is connected to the high potential side node NH via a first switch SW1 and is connected to the ground via the diode D3. A node N4 is connected to the high potential side node NH via a diode D4 and is connected to the ground via a second switch SW2. The generator 52 is connected between the node N3 and the node N4. On-off control of the first switch SW1 and the second switch SW2 is performed by the control device 100.

When the turbine 51 recovers the exhaust energy and the turbine 51 rotates, the rotor in the generator 52 rotates and an induced electromotive force is generated on the coil in the generator 52. The direction of the induced electromotive force in the generator 52 is represented by an arrow in FIG. 8. Here, in a case where both of the first switch SW1 and the second switch SW2 are turned off, electricity is not drawn toward the high potential side node NH and the exhaust turbine power generator 50 enters the “electric power generation state”. In a case where the first switch SW1 is turned off and the second switch SW2 is turned on, a closed circuit (flywheel) as illustrated in FIG. 8 is formed, and thus the exhaust turbine power generator 50 enters the “non-electric power generation state”. The control device 100 can control the electric power generation load within a range of 0% to 100% by performing the on-off control of the second switch SW2 with the first switch SW1 being maintained in the turned-off state (refer to FIG. 7).

During a period in which the exhaust energy is relatively small and the in-turbine recovered work is relatively small (for example, third period P3), the control device 100 may perform “powering control”. Specifically, in a case where both of the first switch SW1 and the second switch SW2 are turned on, electric power is supplied to the generator 52 from the high potential side node NH and the exhaust turbine power generator 50 enters a “powering state”. That is, the generator 52 functions as an electric motor and rotates the turbine 51. The control device 100 can control a powering capability by performing the on-off control of the first switch SW1 with the second switch SW2 being maintained in the turned-off state.

When the powering control of the exhaust turbine power generator 50 is performed, the turbine rotation rate increases. Accordingly, even in an operation state in which the absolute value of the exhaust energy is further smaller, it is possible to perform appropriate electric power generation. That is, it is possible to further expand the engine operating region ROK (refer to FIG. 4) suitable for electric power generation.

### 4. Various Examples of Electric Power Generation Load Control

### 4-1. First Example of Control

FIG. 9 illustrates a change in turbine rotation rate during the exhaust cycle CE. The horizontal axis represents time and the vertical axis represents the turbine rotation rate. As described above, a condition for continuously operating the exhaust turbine power generator 50 at the same operating point is that the turbine rotation rate at the start of one exhaust cycle CE and the turbine rotation rate at the end of the one exhaust cycle CE are the same as each other. Discussion will be made on a preferable way of changing the turbine rotation rate during the exhaust cycle CE under the above-described condition.

In FIG. 9, two patterns are illustrated as patterns of change in turbine rotation rate that satisfy the above-described condition. In a first pattern, an increase in turbine rotation rate in the first half of the exhaust cycle CE is relatively small. Meanwhile, in a second pattern, an increase in turbine rotation rate in the first half of the exhaust cycle CE is relatively large. As illustrated in FIG. 9, the turbine rotation rate pertaining to the case of the second pattern is larger than the turbine rotation rate pertaining to the case of the first pattern over the entire exhaust cycle CE.

Here, note that friction increases in proportion to the “total rotation rate”. Accordingly, in viewpoint of reducing friction loss, the first pattern is more advantageous than the second pattern. The above-described fact means that suppressing an increase in turbine rotation rate as much as possible when the turbine rotation rate increases is preferable. As illustrated in FIG. 5, the first period P1 at the initial stage of the exhaust stroke corresponds to a “time when the turbine rotation rate increases”. Therefore, suppressing an increase in turbine rotation rate during the first period P1 as much as possible is preferable. In order to suppress an increase in the turbine rotation rate, it is sufficient to set the first electric power generation load DUTY1 in the first period P1 to be as large as possible. A first example of the electric power generation load control according to the embodiment is based on the above-described viewpoint.

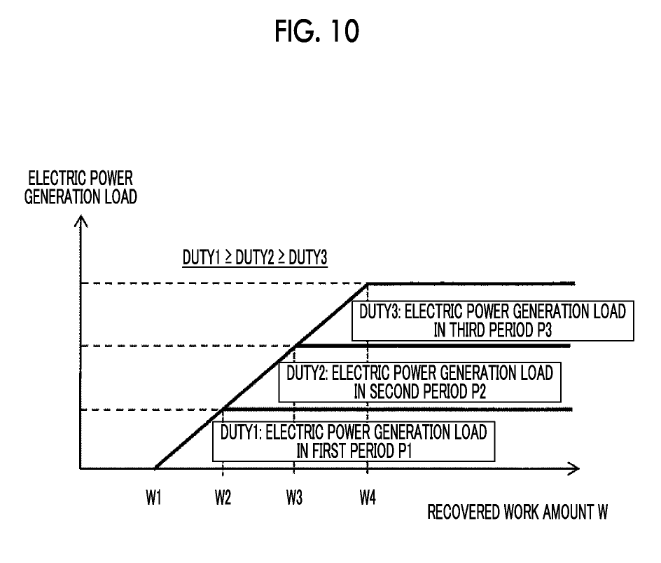

FIG. 10 is a conceptual diagram for describing the first example of the electric power generation load control according to the embodiment. The horizontal axis represents the recovered work amount W and the vertical axis represents allocation of the electric power generation load. Here, the recovered work amount W is the recovered work amount of the turbine 51 in one exhaust cycle CE. The electric power generation load in the first period P1 is the first electric power generation load DUTY1, the electric power generation load in the second period P2 is the second electric power generation load DUTY2, and the electric power generation load in the third period P3 is the third electric power generation load DUTY3.

As the recovered work amount W increases, it becomes possible to allocate a larger electric power generation load as a whole. In this case, in order to suppress an increase in turbine rotation rate as much as possible, setting the first electric power generation load DUTY1 in the first period P1 to be as large as possible is preferable. Therefore, in the first example, an allocatable electric power generation load is allocated for the first electric power generation load DUTY1 preferentially. In a case where the first electric power generation load DUTY1 reaches 100%, the remaining electric power generation load can be allocated for the second electric power generation load DUTY2 or the like.

More specifically, as illustrated in FIG. 10, in a case where the recovered work amount W is within a range of W1 to W2, the first electric power generation load DUTY1 is set within a range of 0% to 100% according to the recovered work amount W and both of the second electric power generation load DUTY2 and the third electric power generation load DUTY3 are set to be 0%. In a case where the recovered work amount W is within a range of W2 to W3, the first electric power generation load DUTY1 is set to be 100%, the second electric power generation load DUTY2 is set within a range of 0% to 100% according to the recovered work amount W, and the third electric power generation load DUTY3 is set to be 0%. In a case where the recovered work amount W is within a range of W3 to W4, both of the first electric power generation load DUTY1 and the second electric power generation load DUTY2 are set to be 100% and the third electric power generation load DUTY3 is set within a range of 0% to 100% according to the recovered work amount W. Accordingly, a relationship of “DUTY1≥DUTY2≥DUTY3” is established. Regardless of the value of the recovered work amount W, the first electric power generation load DUTY1 in the first period P1 is not smaller than the electric power generation load in the other periods.

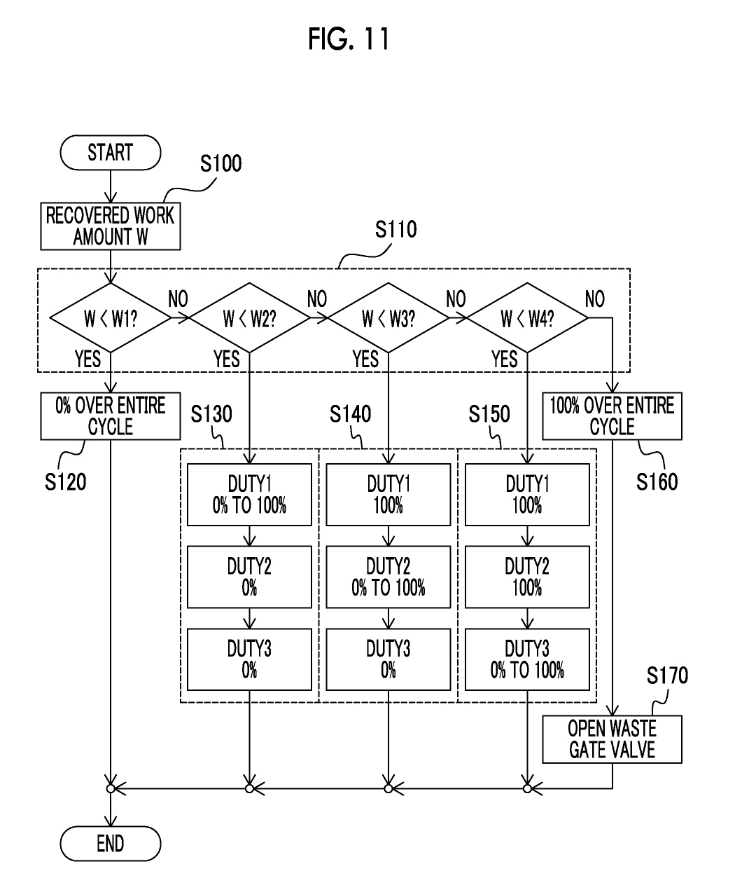

FIG. 11 is a flowchart illustrating the first example of the electric power generation load control according to the embodiment. The control device 100 repeats the flow (routine) illustrated in FIG. 11 for every 180 degrees of crank angle, for example.

Step S100: The control device 100 estimates the recovered work amount W. For example, a map determining a correspondence relationship between input parameters and the recovered work amount W is created in advance and is stored in the storage device of the control device 100. The input parameters are, for example, the engine rotation rate and the requested torque. The engine rotation rate is detected by an engine rotation rate sensor installed in the internal combustion engine 10. The control device 100 calculates an estimated value of the recovered work amount W based on the input parameters and the map.

Step S110: The control device 100 compares the estimated value of the recovered work amount W with various threshold values (W1 to W4). In a case where the estimated value of the recovered work amount W is smaller than a first threshold value W1, the process proceeds to step S120. In a case where the estimated value of the recovered work amount W is equal to or greater than the first threshold value W1 and is smaller than a second threshold value W2, the process proceeds to step S130. In a case where the estimated value of the recovered work amount W is equal to or greater than the second threshold value W2 and is smaller than a third threshold value W3, the process proceeds to step S140. In a case where the estimated value of the recovered work amount W is equal to or greater than the third threshold value W3 and is smaller than a fourth threshold value W4, the process proceeds to step S150. In a case where the estimated value of the recovered work amount W is equal to or greater than the fourth threshold value W4, the process proceeds to step S160.

Step S120: The control device 100 sets all of the first electric power generation load DUTY1, the second electric power generation load DUTY2, and the third electric power generation load DUTY3 to 0%. That is, the control device 100 stops electric power generation performed by the exhaust turbine power generator 50.

Step S130: The control device 100 sets the first electric power generation load DUTY1 within a range of 0% to 100% according to the estimated value of the recovered work amount W. In this case, as the estimated value of the recovered work amount W increases, the first electric power generation load DUTY1 increases. In addition, the control device 100 sets the second electric power generation load DUTY2 and the third electric power generation load DUTY3 to 0%.

Step S140: The control device 100 sets the first electric power generation load DUTY1 to 100%. In addition, the control device 100 sets the second electric power generation load DUTY2 within a range of 0% to 100% according to the estimated value of the recovered work amount W. In this case, as the estimated value of the recovered work amount W increases, the second electric power generation load DUTY2 increases. In addition, the control device 100 sets the third electric power generation load DUTY3 to 0%.

Step S150: The control device 100 sets the first electric power generation load DUTY1 and the second electric power generation load DUTY2 to 100%. In addition, the control device 100 sets the third electric power generation load DUTY3 within a range of 0% to 100% according to the estimated value of the recovered work amount W. In this case, as the estimated value of the recovered work amount W increases, the third electric power generation load DUTY3 increases.

Steps S160, S170: The control device 100 sets all of the first electric power generation load DUTY1, the second electric power generation load DUTY2, and the third electric power generation load DUTY3 to 100% (electric power generation at full rate). Furthermore, the control device 100 opens the waste gate valve 45 (refer to FIG. 1).

According to the first example of the electric power generation load control as described above, the first electric power generation load DUTY1 in the first period P1 in which the turbine rotation rate increases is set to be as large as possible. As a result, an increase in turbine rotation rate in the first period P1 is suppressed as much as possible. When an increase in turbine rotation rate in the first period P1 becomes extremely small, as represented by the first pattern in FIG. 9, the “total rotation rate” in the exhaust cycle CE further decreases. As a result, the friction loss is reduced, and thus the electric power generation efficiency is further improved.

### 4-2. Second Example of Control

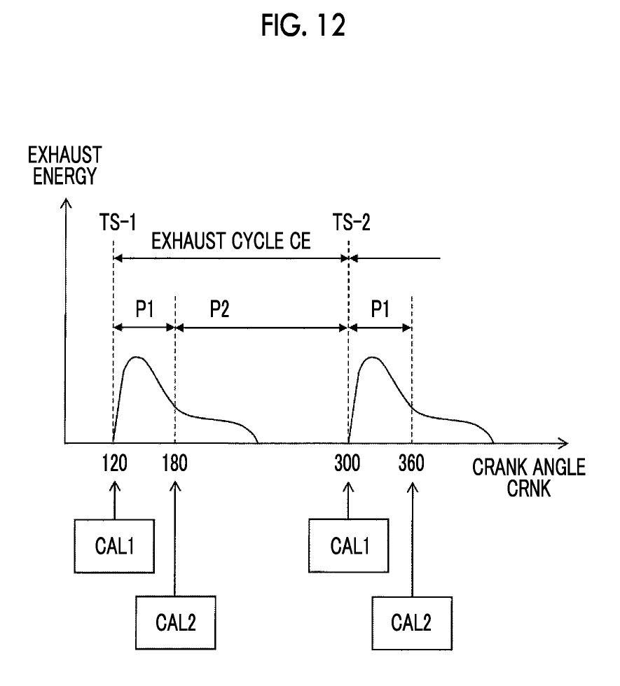

FIG. 12 is a conceptual diagram for describing a second example of the electric power generation load control according to the embodiment. The format of FIG. 12 is the same as the format of FIG. 2. The horizontal axis represents the crank angle CRNK and the vertical axis represents the exhaust energy. In the second example, the entire period in the exhaust cycle CE except the first period P1 is the second period P2.

In the first period P1 which is the initial stage in the exhaust cycle CE, the turbine rotation rate increases. In the second period P2 which is the rest of the exhaust cycle CE, the turbine rotation rate decreases. In order to maintain an appropriate rotation rate, it is preferable to balance the amount of increase in turbine rotation rate in the first period P1 and the amount of decrease in turbine rotation rate in the second period P2. The amount of decrease in turbine rotation rate in the second period P2 increases as the second electric power generation load DUTY2 increases. Therefore, it is possible to realize high-precision turbine rotation rate control by determining the second electric power generation load DUTY2 according to the amount of increase in turbine rotation rate in the first period P1. The second example of the electric power generation load control according to the embodiment is based on the above-described viewpoint.

FIG. 12 also illustrates the timing of determination of the first electric power generation load DUTY1 and the second electric power generation load DUTY2. The control device 100 determines the first electric power generation load DUTY1 at a first determination timing CAL1 and determines the second electric power generation load DUTY2 at a second determination timing CAL2. The first determination timing CAL1 coincides with the timing of the start of the first period P1. The second determination timing CAL2 coincides with the timing of the start of the second period P2.

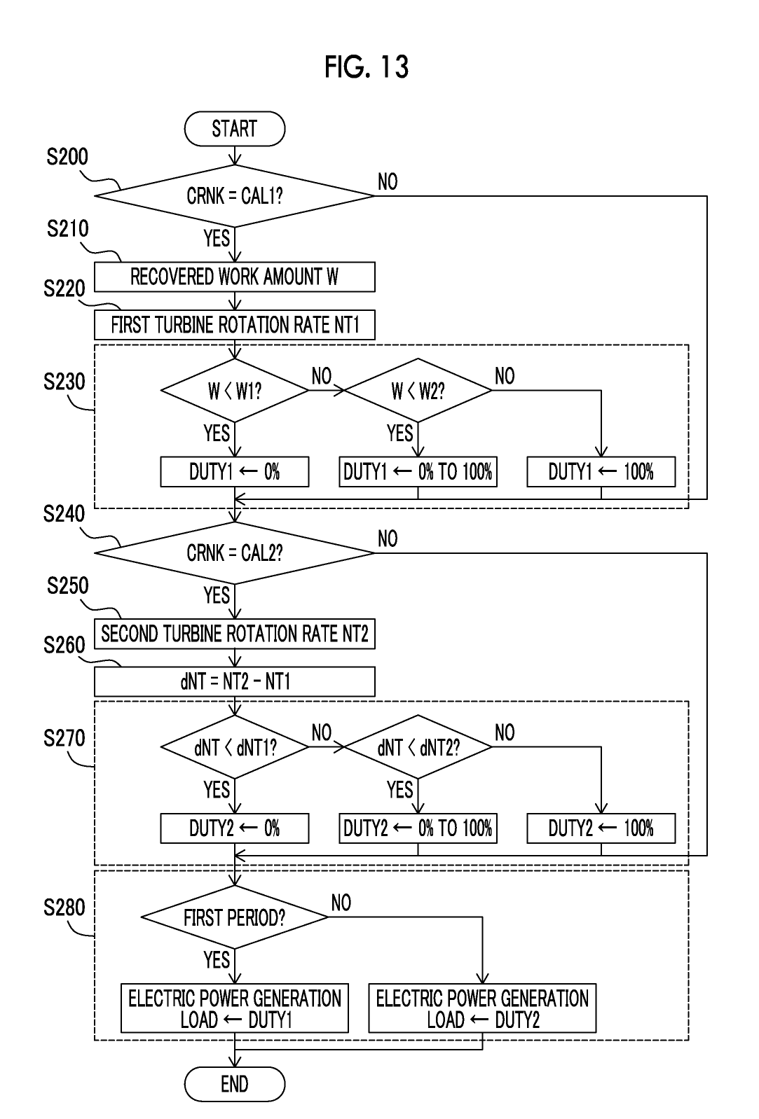

FIG. 13 is a flowchart illustrating the second example of the electric power generation load control according to the embodiment. The control device 100 repeats the flow (routine) illustrated in FIG. 13 for every 30 degrees of crank angle, for example.

Step S200: The control device 100 determines whether the current timing is the first determination timing CALL In a case where the current timing is the first determination timing CAL1 (Yes in step S200), the control device 100 performs steps S210 to S230 as below. Otherwise (No in step S200), the process proceeds to step S240.

Step S210: The control device 100 estimates the recovered work amount W. For example, the control device 100 calculates an estimated value of the recovered work amount W in the same manner as in step S100.

Step S220: The control device 100 acquires a first turbine rotation rate NT1 which is a turbine rotation rate at the first determination timing CAL1. For example, the turbine rotation rate is measured by using a rotation rate sensor provided in the turbine 51. The first turbine rotation rate NT1 corresponds to a turbine rotation rate at the timing of the start of the first period P1.

Step S230: The control device 100 determines the first electric power generation load DUTY1 in the first period P1. Specifically, in a case where the estimated value of the recovered work amount W is smaller than the first threshold value W1, the control device 100 sets the first electric power generation load DUTY1 to 0%. In a case where the estimated value of the recovered work amount W is equal to or greater than the first threshold value W1 and is smaller than a second threshold value W2, the control device 100 sets the first electric power generation load DUTY1 within a range of 0% to 100% according to the estimated value of the recovered work amount W. In this case, as the estimated value of the recovered work amount W increases, the first electric power generation load DUTY1 increases. In a case where the estimated value of the recovered work amount W is equal to or greater than the second threshold value W2, the control device 100 sets the first electric power generation load DUTY1 to 100%.

Step S240: The control device 100 determines whether the current timing is the second determination timing CAL2. In a case where the current timing is the second determination timing CAL2 (Yes in step S240), the control device 100 performs steps S250 to S270 as below. Otherwise (No in step S240), the process proceeds to step S280.

Step S250: The control device 100 acquires a second turbine rotation rate NT2 which is a turbine rotation rate at the second determination timing CAL2. For example, the turbine rotation rate is measured by using the rotation rate sensor provided in the turbine 51. The second turbine rotation rate NT2 corresponds to a turbine rotation rate at the timing of the start of the second period P2.

Step S260: The control device 100 calculates a difference dNT between the second turbine rotation rate NT2 and the first turbine rotation rate NT1. The difference dNT corresponds to the amount of increase in turbine rotation rate in the first period P1. Alternatively, the control device 100 may estimate the amount of increase in turbine rotation rate in the first period P1 based on the engine rotation rate and torque.

Step S270: The control device 100 determines the second electric power generation load DUTY2 in the second period P2 according to the amount of increase in turbine rotation rate in the first period P1. Specifically, in a case where the difference dNT is smaller than a first change threshold value dNT1, the control device 100 sets the second electric power generation load DUTY2 to 0%. In a case where the difference dNT is equal to or greater than the first change threshold value dNT1 and is smaller than a second change threshold value dNT2, the control device 100 sets the second electric power generation load DUTY2 within a range of 0% to 100% according to the difference dNT. In this case, as the difference dNT increases, the second electric power generation load DUTY2 increases. In a case where the difference dNT is equal to or greater than the second change threshold value dNT2, the control device 100 sets the second electric power generation load DUTY2 to 100%.

Step S280: The control device 100 controls the electric power generation load of the exhaust turbine power generator 50. Specifically, in the case of the first period P1, the control device 100 controls the electric power generation load of the exhaust turbine power generator 50 to be the first electric power generation load DUTY1. Meanwhile, in the case of the second period P2, the control device 100 controls the electric power generation load of the exhaust turbine power generator 50 to be the second electric power generation load DUTY2.

According to the second example of the electric power generation load control as described above, the second electric power generation load DUTY2 in the second period P2 is determined according to the amount of increase in turbine rotation rate in the first period P1. Therefore, it is possible to balance the amount of increase in turbine rotation rate in the first period P1 and the amount of decrease in turbine rotation rate in the second period P2. That is, it is possible to realize the high-precision turbine rotation rate control for continuously performing appropriate electric power generation.

### 4-3. Third Example of Control

The control device 100 performs variable control of the timing of opening and closing of the exhaust valve by means of a variable valve timing (VVT) mechanism. The control device 100 changes the timing of the start of the first period P1 in conjunction with opening and closing timing control of the exhaust valve. That is, the control device 100 makes the timing of the start of the first period P1 coincide with the timing of opening of the exhaust valve.

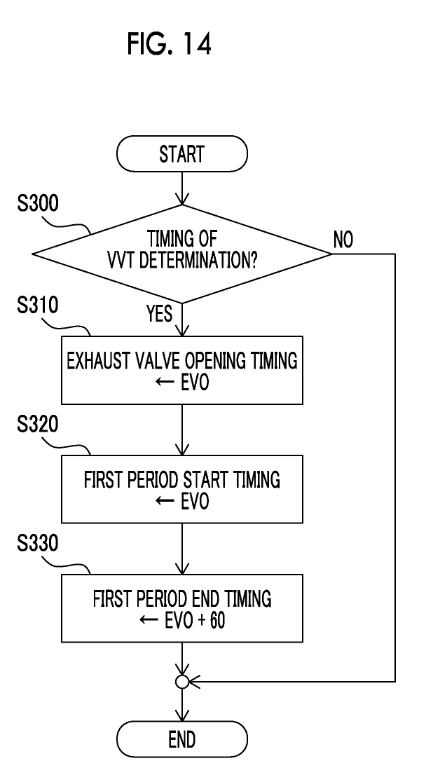

FIG. 14 is a flowchart illustrating a third example of the electric power generation load control in the embodiment. The flow according to the third example is used being combined with that in the above-described other examples of the electric power generation load control.

Step S300: The control device 100 determines whether the current timing is the timing of variable valve timing determination. In a case where the current timing is the timing of variable valve timing determination (Yes in step S300), the control device 100 performs steps S310 to S330 as below. Otherwise (No in step S300), the process flow is terminated.

Step S310: The control device 100 determines a crank angle EVO (deg) as the timing of opening of the exhaust valve.

Step S320: The control device 100 sets the crank angle EVO (deg) as the timing of the start of the first period P1. That is, the control device 100 makes the timing of the start of the first period P1 coincide with the timing of opening of the exhaust valve.

Step S330: The control device 100 sets “crank angle EVO+predetermined value a” (deg) as the timing of the end of the first period P1. The predetermined value a is, for example, 60 degrees of crank angle.

According to the third example of the electric power generation load control as described above, it is possible to reliably synchronize the first period P1 with a period for which the blowdown stream is generated. Therefore, it is possible to efficiently recover the exhaust energy and increase the electric power generation amount.

### 5. Modification Example of Exhaust Turbine Power Generating System

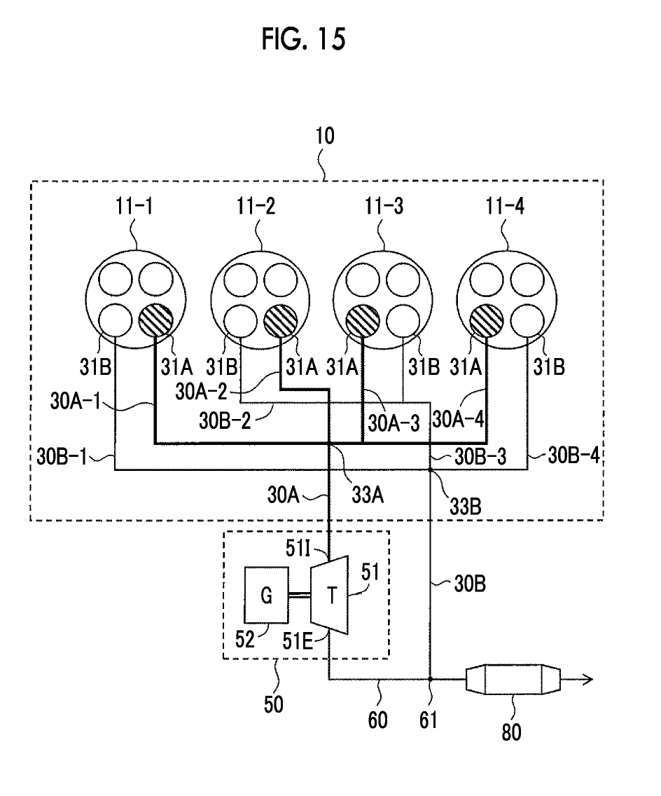

FIG. 15 is a schematic diagram of a modification example of the exhaust turbine power generating system 1 according to the embodiment. In FIG. 15, the electric device 70 and the control device 100 are omitted.

In the modification example, the exhaust path is divided into two systems. That is, the exhaust pipe 30 is divided into a first exhaust pipe 30A (main exhaust pipe) and a second exhaust pipe 30B (sub-exhaust pipe). More specifically, each cylinder 11 includes a first exhaust opening portion 31A and a second exhaust opening portion 31B. The first exhaust pipe 30A is connected to the cylinders 11 via the first exhaust opening portions 31A. Meanwhile, the second exhaust pipe 30B is connected to the cylinders 11 via the second exhaust opening portions 31B.

The first exhaust pipe 30A is used to guide exhaust gas to the turbine 51 of the exhaust turbine power generator 50. Therefore, the first exhaust pipe 30A is disposed such that the first exhaust opening portions 31A and the turbine inlet portion 511 are connected to each other.

Meanwhile, the second exhaust pipe 30B is used to discharge exhaust gas in such a manner that the exhaust gas is discharged without passing through the turbine 51. Therefore, the second exhaust pipe 30B is disposed such that the second exhaust opening portion 31B and the turbine downstream side exhaust pipe 60 are connected to each other not via the turbine 51. That is, the second exhaust pipe 30B constitutes a bypass exhaust path that does not pass through the turbine 51. As illustrated in FIG. 15, the second exhaust pipe 30B is connected to the turbine downstream side exhaust pipe 60 at a bypass connection point 61. The bypass connection point 61 is positioned downstream of the turbine 51 and is positioned upstream of the catalyst 80.

In an example illustrated in FIG. 15, the four cylinders 11-1, 11-2, 11-3, 11-4 are illustrated. First exhaust pipes 30A-i and second exhaust pipes 30B-i are respectively connected to the first exhaust opening portions 31A and the second exhaust opening portions 31B of the cylinders 11-I (i=1 to 4). The first exhaust pipes 30A-i that respectively extend from the cylinders 11-i are connected to the turbine inlet portion 511 after joining each other at a junction 33A. The second exhaust pipes 30B-i that respectively extend from the cylinders 11-i are connected to the bypass connection point 61 on the turbine downstream side exhaust pipe 60 after joining each other at a junction 33B.

Next, the exhaust stroke pertaining to a case where a two-system exhaust path as illustrated in FIG. 15 is present will be described. For description, the exhaust valve provided in the first exhaust opening portion 31A will be referred to as a “first exhaust valve” and the exhaust valve provided in the second exhaust opening portion 31B will be referred to as a “second exhaust valve”.

The first exhaust valve is opened and closed at normal timing. That is, the first exhaust valve is opened near the exhaust bottom dead center and the first exhaust valve is closed near the exhaust top dead center. Before the first exhaust valve is opened, in a combustion and expansion stroke in the internal combustion engine 10, the temperature and the pressure in the cylinders 11 are increased. Therefore, a high-temperature and high-pressure blowdown stream is discharged at a high speed that is close to the speed of sound immediately after the first exhaust valve is opened. The blowdown stream in the initial stage of the exhaust stroke as described above (that is, first period P1) is guided to the turbine 51 through the first exhaust pipe 30A.

The timing of opening of the second exhaust valve and the timing of closing of the second exhaust valve are later than the timing of opening of the first exhaust valve and the timing of closing of the first exhaust valve, respectively. Specifically, the second exhaust valve is opened near a time at which the blowdown caused by the first exhaust valve being opened ends and is closed near the exhaust top dead center. In the late stage of the exhaust stroke, a portion of the exhaust gas is not input to the turbine 51 and is discharged through the second exhaust pipe 30B.

As described above, in a case where the two-system exhaust path is present, exhaust energy input to the turbine 51 in the late stage of the exhaust stroke is further decreased. Therefore, the electric power generation load control according to the embodiment is further effective.

Furthermore, in the exhaust turbine power generating system according to the aspect of the disclosure, the electronic control unit may be configured to set the second electric power generation load to be smaller than the first electric power generation load.

Furthermore, in the exhaust turbine power generating system according to the aspect of the disclosure, the electronic control unit may be configured to set the second electric power generation load to 0% in a case where the first electric power generation load is set to less than 100%. The electronic control unit may be configured to set the second electric power generation load within a range of 0% to 100% in a case where the first electric power generation load is set to 100%.

Furthermore, in the exhaust turbine power generating system according to the aspect of the disclosure, the electronic control unit may be configured to estimate the recovered work amount of the turbine in the exhaust cycle. The electronic control unit may be configured to set the first electric power generation load within a range of 0% to 100% according to the estimated value of the recovered work amount in a case where the estimated value of the recovered work amount is smaller than a threshold value. The electronic control unit may be configured to set the first electric power generation load to 100% and to set the second electric power generation load within a range of 0% to 100% according to the estimated value of the recovered work amount in a case where the estimated value of the recovered work amount is equal to or greater than the threshold value.

Furthermore, in the exhaust turbine power generating system according to the aspect of the disclosure, the electronic control unit may be configured to acquire the amount of increase in turbine rotation rate in the first period and to set the second electric power generation load according to the amount of increase.

Furthermore, in the exhaust turbine power generating system according to the aspect of the disclosure, the electronic control unit may be configured to set the second electric power generation load to 0% in a case where the amount of increase in turbine rotation rate is smaller than a change threshold value. The electronic control unit may be configured to set the second electric power generation load within a range of 0% to 100% according to the amount of increase in a case where the amount of increase in turbine rotation rate is equal to or greater than the change threshold value.

Furthermore, in the exhaust turbine power generating system according to the aspect of the disclosure, the electronic control unit may be configured to estimate a recovered work amount of the turbine in the exhaust cycle. The electronic control unit may be configured to set the first electric power generation load within a range of 0% to 100% according to the estimated value of the recovered work amount in a case where the estimated value of the recovered work amount is smaller than a threshold value. The electronic control unit may be configured to set the first electric power generation load to 100% in a case where the estimated value of the recovered work amount is equal to or greater than the threshold value.

Furthermore, in the exhaust turbine power generating system according to the aspect of the disclosure, the electronic control unit may be configured to perform variable control of the timing of opening of an exhaust valve of the internal combustion engine and to control the first electric power generation load and the second electric power generation load based on the timing of the start of the first period that coincides with the timing of opening of the exhaust valve.

Furthermore, in the exhaust turbine power generating system according to the aspect of the disclosure, the exhaust cycle may include a third period in which exhaust energy becomes smaller than exhaust energy in the first period. The electronic control unit may be configured to perform powering control of the exhaust turbine power generator in the third period.

Furthermore, in the exhaust turbine power generating system according to the aspect of the disclosure, the exhaust turbine power generating system may further include a first exhaust pipe and a second exhaust pipe. Each of cylinders in the internal combustion engine may include a first exhaust opening portion and a second exhaust opening portion. The second exhaust pipe may connect the second exhaust opening portion and a turbine downstream side exhaust pipe downstream of the turbine not via the turbine. The first exhaust pipe may connect the first exhaust opening portion and an inlet portion of the turbine such that the exhaust gas is supplied from the internal combustion engine to the turbine through the first exhaust pipe.

What is claimed is:

1. An exhaust turbine power generating system comprising:
an internal combustion engine;
an exhaust turbine power generator configured to perform electric power generation by rotating a turbine by using exhaust gas from the internal combustion engine; and
an electronic control unit configured to individually control a first electric power generation load of the exhaust turbine power generator in a first period and a second electric power generation load of the exhaust turbine power generator in a second period and to perform control such that the second electric power generation load of the exhaust turbine power generator becomes equal to or smaller than the first electric power generation load, wherein:
the first period is a period that starts at an exhaust start timing in an exhaust cycle;
the second period is a period after the first period in the exhaust cycle;
the exhaust start timing is a timing at which the exhaust gas starts to be discharged toward the turbine from an arbitrary cylinder in the internal combustion engine; and
the exhaust cycle is a period between two temporally consecutive exhaust start timings.

2. The exhaust turbine power generating system according to claim 1, wherein the electronic control unit is configured to set the second electric power generation load to be smaller than the first electric power generation load.

3. The exhaust turbine power generating system according to claim 1, wherein:
the electronic control unit is configured to set the second electric power generation load to 0% in a case where the first electric power generation load is set to less than 100%; and
the electronic control unit is configured to set the second electric power generation load within a range of 0% to 100% in a case where the first electric power generation load is set to 100%.

4. The exhaust turbine power generating system according to claim 3, wherein:
the electronic control unit is configured to estimate a recovered work amount of the turbine in the exhaust cycle;
the electronic control unit is configured to set the first electric power generation load within a range of 0% to 100% according to an estimated value of the recovered work amount in a case where the estimated value of the recovered work amount is smaller than a threshold value; and
the electronic control unit is configured to set the first electric power generation load to 100% and to set the second electric power generation load within a range of 0% to 100% according to the estimated value of the recovered work amount in a case where the estimated value of the recovered work amount is equal to or greater than the threshold value.

5. The exhaust turbine power generating system according to claim 1, wherein the electronic control unit is configured to acquire an amount of increase in turbine rotation rate in the first period and to set the second electric power generation load according to the amount of increase.

6. The exhaust turbine power generating system according to claim 5, wherein:
the electronic control unit is configured to set the second electric power generation load to 0% in a case where the amount of increase in turbine rotation rate is smaller than a change threshold value; and
the electronic control unit is configured to set the second electric power generation load within a range of 0% to 100% according to the amount of increase in a case where the amount of increase in turbine rotation rate is equal to or greater than the change threshold value.

7. The exhaust turbine power generating system according to claim 5, wherein:
the electronic control unit is configured to estimate a recovered work amount of the turbine in the exhaust cycle;
the electronic control unit is configured to set the first electric power generation load within a range of 0% to 100% according to an estimated value of the recovered work amount in a case where the estimated value of the recovered work amount is smaller than a threshold value; and
the electronic control unit is configured to set the first electric power generation load to 100% in a case where the estimated value of the recovered work amount is equal to or greater than the threshold value.

8. The exhaust turbine power generating system according to claim 1, wherein the electronic control unit is configured to perform variable control of a timing of opening of an exhaust valve of the internal combustion engine and to control the first electric power generation load and the second electric power generation load based on a timing of a start of the first period that coincides with the timing of opening of the exhaust valve.

9. The exhaust turbine power generating system according to claim 1, wherein:
the exhaust cycle includes a third period in which exhaust energy becomes smaller than exhaust energy in the first period; and
the electronic control unit is configured to perform powering control of the exhaust turbine power generator in the third period.

10. The exhaust turbine power generating system according to claim 1, further comprising:
a first exhaust pipe; and
a second exhaust pipe, wherein:
each of cylinders in the internal combustion engine includes a first exhaust opening portion and a second exhaust opening portion;
the second exhaust pipe connects the second exhaust opening portion and a turbine downstream side exhaust pipe downstream of the turbine not via the turbine; and
the first exhaust pipe connects the first exhaust opening portion and an inlet portion of the turbine such that the exhaust gas is supplied from the internal combustion engine to the turbine through the first exhaust pipe.

11. A control device for an exhaust turbine power generating system including an internal combustion engine and an exhaust turbine power generator, the exhaust turbine power generator being configured to perform electric power generation by rotating a turbine by using exhaust gas from the internal combustion engine, the control device comprising an electronic control unit configured to individually control a first electric power generation load of the exhaust turbine power generator in a first period and a second electric power generation load of the exhaust turbine power generator in a second period and to perform control such that the second electric power generation load of the exhaust turbine power generator becomes equal to or smaller than the first electric power generation load, wherein:
the first period is a period that starts at an exhaust start timing in an exhaust cycle;
the second period is a period after the first period in the exhaust cycle;
the exhaust start timing is a timing at which the exhaust gas starts to be discharged toward the turbine from an arbitrary cylinder in the internal combustion engine; and
the exhaust cycle is a period between two temporally consecutive exhaust start timings.
